(19) United States
(12) Patent Application Publication
(10) Pub. No.: US 2009/0283594 A1
(43) Pub. Date: Nov. 19, 2009

(54) METHOD OF BUNDLING ACTIVATION AND SALES OF GIFT CARDS

(76) Inventors: Gretchen Walton, Maineville, OH (US); Clare Reilly, Cincinnati, OH (US); Gregg Cosco, Loveland, OH (US)

Correspondence Address: BARLOW, JOSEPHS & HOLMES, LTD., 101 DYER STREET, 5TH FLOOR, PROVIDENCE, RI, 02903, US

(21) Appl. No.: 12/468,502

(22) Filed: May 19, 2009

Related U.S. Application Data
(60) Provisional application No. 61/054,232, filed on May 19, 2008.

(51) Int. Cl. G06F 17/00

(52) U.S. Cl. 235/383

(57) ABSTRACT

A method for bundling the activation and sale of gift cards is provided whereby a plurality of gift cards is packaged together into a multi-pack that is then purchased and activated in a single transaction. In this manner, electronic transaction cards are bundled such that there is more than one card in a single package. The customer is then presented with a variety of the electronic transaction card multi-packs for consideration and purchase. Upon making their selection, the customer takes the multi-pack to a cashier to complete a traditional checkout and purchase operation. The cards are then bulk activated at an activation terminal. This allows a person purchasing a multi-pack, for example to purchase three $25.00 gift cards for their face value plus one activation fee and then distribute each of those cards to a different individual as a gift.

### CROSS-REFERENCE TO RELATED APPLICATIONS

This application is related to and claims priority from earlier filed U.S. Provisional Patent Application No. 61/054,232, filed May 19, 2008.

### BACKGROUND OF THE INVENTION

The present invention relates generally to a method for bundling and activating gift cards for single sales of multiple units. More specifically, the present invention relates to a product package that includes several individual gift cards bundled as a single unit that can be purchased and activated as a single unit in a manner that reduces the need for multiple activations and the fees associated therewith.

The use of electronic transaction cards in the form of stored value cards, gift cards or other prepaid metered account cards has gained widespread acceptance and is well known in the art for providing consumers with access to goods and services. The purchase and usage of these prepaid transaction cards has continued to increase in recent years to the point that the sale of prepaid transaction cards today is a multi-billion dollar industry. For example, most retail locations offer consumers the opportunity to purchase stored value cards or gift cards. Similarly, pre-paid debit cards are also frequently available for purchase for telephone services.

In the past, traditional prepaid transaction cards were printed and issued with a predetermined balance. These prepaid cards are then displayed at a retail location wherein a customer can make a selection of the desired card and purchase it in a traditional retail transaction. An example of such a card is a pre-paid gift card, which provides an individual with a set dollar amount for the purchase of goods from a particular merchant. The account is accessed and debited by using an account number provided on the gift card. However, since this type of prepaid card has a cash value the retailer offering them for sale is subsequently more exposed to loss through shrinkage and theft. As a result, a retailer using a prepaid type card that has a cash value typically stores them under lock and key until the moment the cards are purchased. This in turn prevents stocking of such cards on store shelves in a manner that is freely accessible by prospective purchasers and increases retailer handling time and expense. In addition, the retailer must maintain inventory stock of different values of these pre-paid debit cards well in advance of the time at which the debit cards are actually sold as a retail item, thus restricting working capital.

To overcome this problem, most retailers have instead adopted the use of electronic transaction cards that are not initially activated. Since these cards do not have any cash value prior to their activation, the retailer can readily put the cards out on display for the prospective customer, thereby reducing handling time and costs, as theft is no longer a concern. Further, retailers no longer have a large initial expenditure in order to provide an inventory of cards since the transaction card is activated with a predominated value printed on the card or any specified balance representing an amount a consumer wishes to attribute to the card at the time the card is actually purchased by the consumer.

Typically, these transaction cards are displayed and/or packaged individually for sale in a retail store by affixing the card to a card carrier, wherein the card is typically affixed to the card carrier by adhesives or by inserting corners of the card into openings within the card carrier and terms and conditions of use are inserted into the package. The new issue that has arisen is that since each and every card must be individually activated and has its own card carrier this packaging method is often cumbersome in that the merchant has to first remove the card from the packaging in which the card is displayed in order to activate the card at the time the card is actually sold. Further, the individual card packaging increases the operating costs and requires that a consumer who is purchasing multiple transaction cards must frequently pay an activation fee for each card that is purchased.

There is therefore a need to provide a method and system for facilitating the purchase and activation of gift cards in multi-card packages. There is a further need for a method of bundling activation and packaging of individual gift cards in a manner that simplifies the packaging needed, the handling required for activation and the overall cost charged for activation fees.

### BRIEF SUMMARY OF THE INVENTION

In this regard, the present invention provides a method for bundling the activation and sale of gift cards. More specifically, the present invention provides a method and system whereby a plurality of gift cards is packaged together into a multi-pack, wherein the selected multi-pack is then purchased and activated in a single transaction.

In accordance with the present invention, electronic transaction cards such as gift cards and prepaid cards for goods and services are bundled such that there is more than one card in a single package. In one embodiment, the present invention may include a plurality of electronic gift cards that all have the same denomination such as for example a package of three $25.00 cards. Similarly, in another embodiment such a multi-pack bundle may contain cards of different denominations such as two $15.00 cards and two $30.00 cards. It should be appreciated by one skilled in the art that combination of possible number of cards and the denominations listed thereon is virtually limitless and that the spirit of the present invention is intended to cover any possible combination of electronic gift cards having denominations that are packaged as a bundle for bulk sale thereof.

The customer is then presented with a variety of the electronic transaction card multi-packs for consideration and purchase. Upon making their selection, the customer takes the multi-pack to a cashier to complete a traditional checkout and purchase operation. It should be appreciated that such a checkout and purchase operation may be conducted at a bricks and mortar location or through a virtual retailer with equal efficacy and still fall within the disclosed scope of the present invention. In the prior art, a customer who selected multiple electronic transaction cards would be required to purchase each item as a single object wherein the cost of the item was entered into the register and the cashier would then have to activate each electronic transaction card individually. In turn the customer would then be charged individual activation fees for each individual card that was purchased and activated.

In contrast to the prior art methods, in the present invention, the multi-pack of electronic transaction cards is purchased and activated as a single item wherein the customer realizes a savings of at least the cost of multiple activation fees for the plurality of cards that are activated. It is further possible within the scope of the present invention that the customer may be provided with a discount on the face value of the bundled cards as well to provide an additional incentive to select and purchase a multi-pack of the electronic transaction cards.

In proceeding with the activation, such bulk activation may be accomplished by accessing a code or magnetically encoded information on each of the cards or may be accomplished through a code on the multi-pack packaging material wherein the code provides the activation terminal with information that indicates that multiple cards have been activated. In addition, it is possible that the packaging be constructed in a manner that allows individual codes on each of the individual gift cards either though a flap or an opening in the packaging. Regardless of the mechanism used to activate the plurality of cards, it is the intent of the present invention to allow each of the cards contained in the multi-pack to be activated so that the individual cards can each stand on their own after the multi-pack has been purchased and activated. This allows a person purchasing a multi-pack, for example to purchase three $25.00 gift cards for their face value plus one activation fee and then distribute each of those cards to a different individual as a gift.

The cost of purchasing such a multi-pack is then the sum of the denominations of cards contained within the package plus the cost of one activation fee. Optionally, the cost of the purchase may be the sum of the denominations of the cards less a discount value plus the cost of one activation fee.

Accordingly, it is an object of the present invention to provide a method and system for facilitating the purchase and activation of gift cards in multi-card packages. It is a further object of the present invention to provide a method of bundling activation and packaging of individual gift cards in a manner that simplifies the packaging needed, the handling required for activation and the overall cost charged for activation fees.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a multi-pack electronic transaction card bundle in accordance with the method of the present invention;

FIG. 2 is a flow chart describing the method of the present invention;

FIG. 3a is a multi-pack electronic transaction card bundle with an activation code printed on one of the cards and visible through an opening in the packaging;

FIG. 3b is a multi-pack electronic transaction card bundle with an activation code printed on the packaging;

FIG. 3c is a multi-pack electronic transaction card bundle wherein the activation code is contained on a magnetic strip on the card itself; and

FIG. 3d is a multi-pack electronic transaction card bundle with an activation code printed on each of the cards and visible through openings in the packaging.

### DETAILED DESCRIPTION OF THE INVENTION

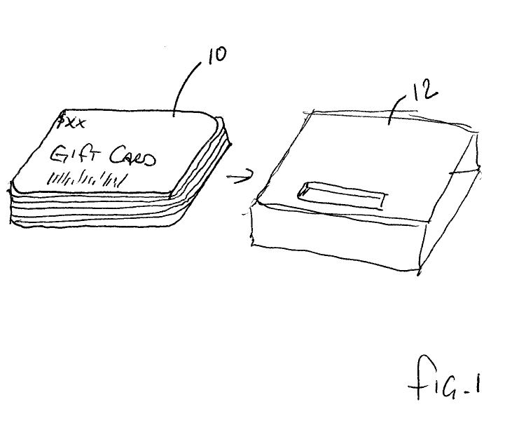

Now referring to the drawings, gift card packaging and activation method and system is shown and generally illustrated in the figures. In the most general embodiment as shown at FIG. 1, the present invention provides for the bundling of electronic transaction cards 10, such as gift cards and/or prepaid cards for goods and services and/or reloadable transaction cards such that there is more than one card in a single package 12. In this manner there is a plurality of at least two electronic transaction cards 10 that are placed into a single packaging vehicle 12 for sale as a single item.

It can be appreciated by one skilled in the art that, the present invention may include a plurality of electronic gift cards 10 that all have the same denomination such as for example a single package of three $25.00 cards. Similarly, a multi-pack bundle of electronic transaction cards 10 may contain cards of different denominations such as two $15.00 cards and two $30.00 cards. It should be further appreciated by one skilled in the art that combination of possible number of electronic transaction cards 10 and the denominations listed thereon is virtually limitless and that the spirit of the present invention is intended to cover any possible combination of electronic transaction cards 10 having any variety of denominations that are packaged as a bundle for bulk sale thereof.

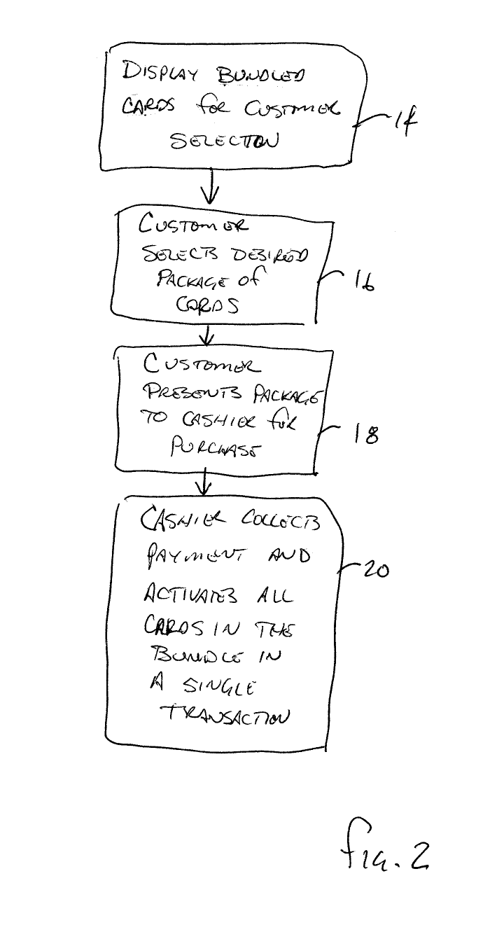

In accordance with the method as depicted at FIG. 2, the multi pack bundles of cards are displayed for purchase by a customer 14. Such a display may be at a traditional or at an online retail location. The customer is then presented with a variety of the electronic transaction card multi-packs for consideration and purchase. Upon making their selection 16, the customer takes the multi-pack to a cashier to complete a traditional checkout and purchase operation 1 8. It should be appreciated that such a checkout and purchase operation may be conducted at a bricks and mortar location or through a virtual retailer with equal efficacy and still fall within the disclosed scope of the present invention. In the prior art, a customer who selected multiple electronic transaction cards would be required to purchase each item as a single object wherein the cost of the item was entered into the register and the cashier would then have to activate each electronic transaction card individually. In turn the customer would then be charged individual activation fees for each individual card that was purchased and activated.

In contrast to the prior art methods, in the present invention, the multi-pack of electronic transaction cards is purchased and activated as a single item 20 wherein the customer realizes a savings of at least the cost of multiple activation fees for the plurality of cards that are activated. It is further possible within the scope of the present invention that the customer may be provided with a discount on the face value of the bundled cards as well to provide an additional incentive to select and purchase a multi-pack of the electronic transaction cards. For example, if the customer were to buy four individual $25 cards, the cost would be $100 plus four activation charges. In contrast, in the present invention the four $25 cards are bundled together wherein the cost would be $100 plus one activation charge. If a discount were also provided, the cost may be reduced by a discount percentage that is acceptable to the merchant in order to provide an incentive to purchase the multi-pack. A 5% discount may be used in connection with the multipack bundle allowing the customer in the above example to save an additional $5 as well as saving the additional 3 activation fees.

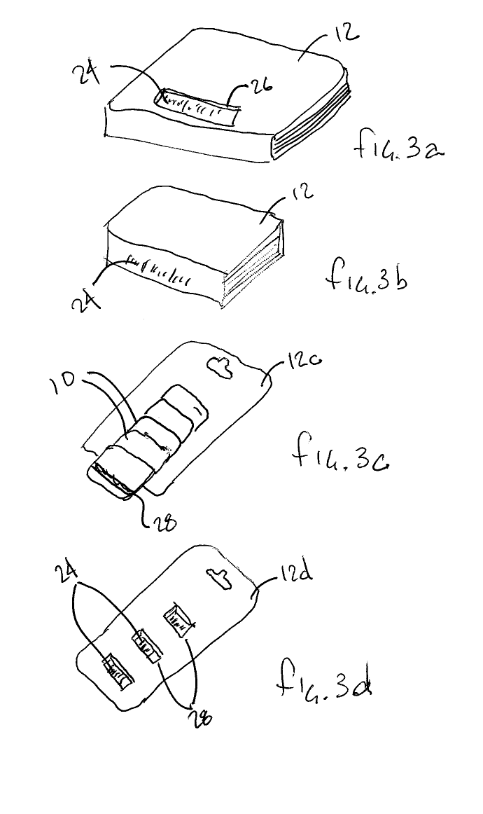

As can be seen in FIGS. 3a-3d, in proceeding with the activation, such bulk activation of all of the cards may be accomplished by accessing a code 24 that is printed on the package 12, on one of the bundled cards 10 themselves such that the code 24 is visible through an opening 26 in the package 12, or on magnetically encoded information 28 on the cards. Similarly, activation may be accomplished through a code 24 on the multi-pack packaging material wherein the code 24 provides the activation terminal with information that indicates that multiple cards 10 have been activated. Generally, in the scope of the present invention it is preferred that a code be used for activation that singularly represents all of the cards 10 in the package 12 thereby serving to activate all of the cards 10 simultaneously when the singular code is entered into the system. For example, the code on the multi-pack may represent the serial numbers of the cards contained therein either literally or in a representative manner. In addition, it is possible that the packaging 12d be constructed in a manner that allows individual codes 24 on each of the individual gift cards 12 either though a flap or an opening 28 in the packaging where a unique code on each card can be read at the time of activation. Regardless of the mechanism used to activate the plurality of cards, it is the intent of the present invention to allow each of the cards contained in the multi-pack to be activated so that the individual cards can each stand on their own after the multi-pack has been purchased and activated. This allows a person purchasing a multi-pack, for example to purchase three $25.00 gift cards for their face value plus one activation fee and then distribute each of those cards to a different individual as a gift.

In the preferred embodiment, the cost of purchasing such a multi-pack is then the sum of the denominations of cards contained within the package. Further, in an alternate method, the purchase price may be the sum of the denominations of cards contained within the package plus the cost of one activation fee. Still further, the cost of the purchase may be the sum of the denominations of the cards less a discount value that is provided to the customer for making a single purchase of a plurality of gift cards, plus the cost of one activation fee.

Accordingly, it can be seen that the present invention provides a method and system for facilitating the purchase and activation of gift cards in multi-card packages wherein the single activation and packaging of a plurality of individual gift cards simplifies the packaging needed, the handling required for activation and the overall cost charged for activation fee. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A bundled package for electronic transaction cards comprising:
a plurality of electronic transaction cards each having a value and requiring activation;
a package for receiving and retaining said plurality of electronic transaction cards; and
a code that represents the number and value of all of the electronic transaction cards in said plurality of electronic transaction cards.

2. The bundled package for electronic transaction cards of claim 1, wherein each of the cards in said plurality of electronic transaction cards is activated in a single transaction via said code.

3. The bundled package for electronic transaction cards of claim 1, wherein said code is on said package.

4. The bundled package for electronic transaction cards of claim 1, wherein said code is on at least one of said electronic transaction cards, said code being readable through an opening provided in said package.

5. The bundled package for electronic transaction cards of claim 1, wherein said value represented by said code is the sum of the value of each of the transaction cards.

6. The bundled package for electronic transaction cards of claim 1, wherein said value represented by said code is the sum of the value of each of the transaction cards less a discount value.

7. The bundled package for electronic transaction cards of claim 1, wherein the value of each of the transaction cards is equal to one another.

8. The bundled package for electronic transaction cards of claim 1, wherein the value of at least one of the transaction cards is different from the value of the remaining transaction cards.

9. The bundled package for electronic transaction cards of claim 1, wherein each of the transaction cards can be used separately from the remaining plurality of transaction cards after said plurality of transaction cards has been activated.

10. The bundled package for electronic transaction cards of claim 1, wherein the transaction cards are selected from the group consisting of: gift cards, prepaid cards for goods and services and reloadable transaction cards.

11. A method of purchasing a bundled package for electronic transaction cards comprising:
selecting a prepackaged transaction card bundle comprising:
a plurality of electronic transaction cards each having a value and requiring activation;
a package for receiving and retaining said plurality of electronic transaction cards; and
a code that represents the number and value of all of the electronic transaction cards in said plurality of electronic transaction cards;
presenting said prepackaged transaction card bundle for a purchase transaction at a terminal;
scanning said code on prepackaged transaction card bundle at said a terminal, wherein each of said plurality of transaction cards is upon completion of said transaction; and
paying the required value to complete said transaction.

12. The method claim 11, wherein each of the cards in said plurality of electronic transaction cards is activated in a single transaction via said code.

13. The method claim 11, wherein said code is on said package.

14. The method claim 11, wherein said code is on at least one of said electronic transaction cards, said code being readable through an opening provided in said package.

15. The method claim 11, wherein said value represented by said code is the sum of the value of each of the transaction cards.

16. The method claim 11, wherein said value represented by said code is the sum of the value of each of the transaction cards less a discount value.

17. The method claim 11, wherein the value of each of the transaction cards is equal to one another.

18. The method claim 11, wherein the value of at least one of the transaction cards is different from the value of the remaining transaction cards.

19. The method claim 11, wherein each of the transaction cards can be used separately from the remaining plurality of transaction cards after said plurality of transaction cards has been activated.

20. The method claim 11, wherein the transaction cards are selected from the group consisting of: gift cards, prepaid cards for goods and services and reloadable transaction cards.
